(19) United States
(12) Patent Application Publication
(10) Pub. No.: US 2021/0383706 A1
(43) Pub. Date: Dec. 9, 2021

(54) SYSTEM AND METHODS FOR IMPROVING AIRCRAFT FLIGHT PLANNING

(71) Applicant: ApiJet LLC, Seattle, WA (US)

(72) Inventors: Robert Thomas Gibbons, II, Seattle, WA (US); Thomas Jay Horsager, Grove Heights, MN (US); Eric Sabbaton Merrifield, JR., Seattle, WA (US)

(21) Appl. No.: 17/338,203

(22) Filed: Jun. 3, 2021

Related U.S. Application Data
(60) Provisional application No. 63/035,156, filed on Jun. 5, 2020.

(51) Int. Cl. G08G 5/00; G07C 5/08; G06N 3/08

(52) U.S. Cl. CPC G08G 5/0039; G06N 3/08; G07C 5/0808; G08G 5/0021

(57) ABSTRACT

Systems, apparatuses, and methods for more effectively providing pilots with optimal suggested route or trajectory changes during flight. This is achieved by at least two primary improvements: (1) expanding the set of available aircraft performance “models” used in the TASAR system's generation of recommended flight trajectory changes to account for the characteristics of a larger set of aircraft; and (2) modifying a baseline model for a type of aircraft to take into account the operating characteristics and condition of an individual aircraft. The baseline model may be generated by collecting data regarding the characteristics of a set of aircraft having a common manufacturer, type (e.g., airframe or class), and specific features. The collected operational and performance data may be used as input data or “features” for a machine learning algorithm to generate a parameter of a performance model.

### CROSS REFERENCE TO RELATED APPLICATION

This application claims the benefit of U.S. Provisional Application No. 63/035,156, titled “System and Method for Improving Aircraft Flight Planning,” filed Jun. 5, 2020, the disclosure of which is incorporated, in its entirety (including the Appendix) herein, by this reference.

### BACKGROUND

An important aspect of operating an aircraft is flight planning and the optimization of flight trajectories as an aircraft encounters weather and other hazards. Flight path changes may be applied to accomplish one or more of minimizing fuel consumption, avoiding turbulence, or reducing transit time. One system for calculating or performing these route and trajectory changes or optimizations is referred to as the Traffic Aware Strategic Aircrew Requests system, sometimes abbreviated as TASAR. The TASAR system was developed by NASA and is available for use by the flight crew of an aircraft, typically as an application that is part of their Electronic Flight Bag System (EFB). The TASAR system includes a software application, a server component, a ground feed provided set of services, and a configuration component. Together these components and processes are used to plan and optimize aircraft trajectory and form what is termed a Traffic Aware Planner (TAP). The TAP functional module(s) automatically monitor for flight optimization opportunities in the form of lateral and/or vertical changes to the flight trajectory.

A detailed description of the TASAR system and its capabilities may be found in the document entitled “Traffic Aware Strategic Aircrew Requests (TASAR), Traffic Aware Planner (TAP), Interface Control Document (ICD)” contained in the Appendix to U.S. Provisional Application No. 63/035,149, titled “System and Method for Community Provided Weather Updates for Aircraft,” filed Jun. 5, 2020. Additional information on the TASAR system may be found on-line from NASA and other sources.

The TASAR system includes an automated cockpit component that monitors data and sensor feeds for potential improvements to the flight trajectory and displays these to a pilot. The potential flight trajectory changes are evaluated for potential conflicts with known airplane traffic, known weather hazards, and airspace restrictions. However, any actual route change must be authorized by Air Traffic Control, and depending on policy, sometimes also Airline Dispatch. One objective of the TASAR system is to improve the process by which pilots request flight path and altitude modifications due to changing flight conditions. As noted, changes may be requested to reduce flight time, decrease fuel consumption, or improve another flight attribute desired by the operator of an aircraft.

The required or recommended flight path trajectory modifications or optimizations may depend on the characteristics of an aircraft. This is understandable, as different aircraft shapes, sizes, features (such as tail or wing design, the presence of wingless, etc.) can impact fuel consumption and aircraft performance. Furthermore, due to normal usage, an individual aircraft may develop performance characteristics that differ from a new and unused example of the same aircraft. As a result, in order to generate the “best” and most optimal flight trajectory paths under typical operating conditions, information regarding the specific aircraft model being flown (i.e., type, manufacturer, model number, version, etc.), and if possible, the actual aircraft itself would be desirable to be available as an input to the TASAR system.

Unfortunately, the TASAR system has a limited number of aircraft “models” or parameter sets available for use in determining recommended trajectory changes. These parameter sets are fixed in the sense that the parameters do not change over time for each “model” (or set of parameters), and hence fail to take into account changes to an individual aircraft's characteristics over time and with usage. Further, while useful, this approach is inherently limited as it fails to provide models for all (or at least more) of the existing types of aircraft being flown that may utilize the TASAR system. Thus, systems and methods are needed for more efficiently and correctly making aircraft trajectory optimizations based on the characteristics of an individual aircraft, or at least of a set of aircraft closer in characteristics to an individual aircraft. Embodiments of the disclosure are directed toward solving these and other problems individually and collectively.

### SUMMARY

The terms “invention,” “the invention,” “this invention,” “the present invention,” “the present disclosure,” or “the disclosure” as used herein are intended to refer broadly to all of the subject matter described in this document, the drawings or figures, and to the claims. Statements containing these terms should be understood not to limit the subject matter described herein or to limit the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments are directed to systems, apparatuses, and methods for improving the selection or modification of an aircraft's trajectory based on the operating and flight characteristics of the individual aircraft. The selection or modification of the trajectory may be recommended to optimize time of flight, reduce fuel consumption, avoid turbulence, or for other reasons. In some embodiments, this improvement to conventional approaches to flight planning is achieved by using machine learning and other data processing or modeling techniques to determine how the characteristics of an individual aircraft change over time, and how those changes alter parameters of an aircraft “model” used in the flight planning process. In some embodiments, a baseline aircraft performance model or parameter set may be varied to generate a model that more accurately represents the characteristics of a set of aircraft (e.g., based on a manufacturer and airframe type), an individual aircraft, or aircraft having certain characteristics in common with an individual aircraft for which a trajectory is being planned (such as based on features or characteristics found to be most relevant in affecting flight performance for an aircraft of that general size, shape, or service miles).

In some embodiments, deviations from the performance “predicted” or expected using a baseline aircraft performance model may be determined for an individual aircraft (such as flight time, fuel consumption, drag, lift, etc.). The deviations may be used in a process to update or revise the baseline performance model used in trajectory planning for that aircraft or for a similar set of aircraft. This enables TASAR to more accurately “predict” flight performance and provide more effective route planning. In some embodiments, collection of a suitable set of data from multiple aircraft and the training of a machine learning model may enable the system described herein to identify the characteristics of an aircraft that have the most significant impact on the baseline model parameters, and hence on the trajectory planning process.

In some embodiments, the methods include a process, method, function, or operation performed in response to the execution of a set of computer-executable instructions or software, where the instructions are stored in (or on) one or more non-transitory electronic data storage elements or memory. In some embodiments, the set of instructions may be conveyed to an aircraft or to a network element with which the aircraft is in communication from a remote server over a network. The set of instructions may be executed by an electronic processor or data processing element (e.g., CPU, GPU, controller, etc.). The data processing element may be contained in an on-board system, a remote server, a network element, a handheld device, or in some cases, another aircraft.

In one embodiment, the disclosure is directed to a system for providing a suggested route or trajectory change for an aircraft. The system may comprise a set of computer-executable instructions and a processor or processors programmed to execute the set of instructions. When executed, the set of instructions may cause the processor or processors (or a device or apparatus in which the processor or processors are contained) to perform one or more operations or functions where the operations or functions comprise:
obtain a baseline model representing flight performance parameters of an aircraft;
based on the baseline model, generate a flight trajectory and expected flight performance parameters for the aircraft following that trajectory;
monitor actual flight performance parameters as the aircraft is flown along the generated flight trajectory;
compare the actual flight performance parameters to the expected flight performance parameters;
determine if there is a difference between the actual flight performance parameters and the expected flight performance parameters; and
if there is a difference, then modifying the baseline model based on the difference.

In some embodiments, the system may further perform operations or functions comprising:
generating a revised trajectory using the modified baseline model; and
presenting the revised trajectory to a pilot, wherein
the baseline model is one of a set of aircraft performance models based on one or more of the manufacturer, airframe, or age of the aircraft; and
the set of aircraft performance models is obtained by a process comprising:
   collecting operational and performance data for each of a plurality of aircraft; and
   training a machine learning model to output a parameter of an aircraft performance model from an input to the model, the input comprising operational or performance data for a different aircraft.

In another embodiment, the disclosure is directed to a method for providing a suggested route or trajectory change for an aircraft, where the method may include one or more operations or functions, where the operations or functions comprise:
obtaining a baseline model representing flight performance parameters of an aircraft;
based on the baseline model, generating a flight trajectory and expected flight performance parameters for the aircraft following that trajectory;
monitoring actual flight performance parameters as the aircraft is flown along the generated flight trajectory;
comparing the actual flight performance parameters to the expected flight performance parameters;
determining if there is a difference between the actual flight performance parameters and the expected flight performance parameters; and
if there is a difference, then modifying the baseline model based on the difference.

In some embodiments, the method may further comprise:
generating a revised trajectory using the modified baseline model; and
presenting the revised trajectory to a pilot, wherein
the baseline model is one of a set of aircraft performance models based on one or more of the manufacturer, airframe, or age of the aircraft; and
the set of aircraft performance models is obtained by a process comprising:
   collecting operational and performance data for each of a plurality of aircraft; and
   training a machine learning model to output a parameter of an aircraft performance model from an input to the model, the input comprising operational or performance data for a different aircraft.

In yet another embodiment, the disclosure is directed to a set of computer-executable instructions, wherein when executed by a processor or processors, the set of instructions cause the processor or processors (or a device or apparatus in which the processor or processors are contained) to perform one or more operations or functions for providing a suggested route or trajectory change for an aircraft, where the operations or functions comprise:
obtaining a baseline model representing flight performance parameters of an aircraft;
based on the baseline model, generating a flight trajectory and expected flight performance parameters for the aircraft following that trajectory;
monitoring actual flight performance parameters as the aircraft is flown along the generated flight trajectory;
comparing the actual flight performance parameters to the expected flight performance parameters;
determining if there is a difference between the actual flight performance parameters and the expected flight performance parameters; and
if there is a difference, then modifying the baseline model based on the difference.

In some embodiments, the set of computer-executable instructions may further comprise instructions that cause the processor or processors to perform operations or functions that comprise:
generating a revised trajectory using the modified baseline model; and
presenting the revised trajectory to a pilot, wherein
the baseline model is one of a set of aircraft performance models based on one or more of the manufacturer, airframe, or age of the aircraft; and
the set of aircraft performance models is obtained by a process comprising:
   a collecting operational and performance data for each of a plurality of aircraft; and
   a training a machine learning model to output a parameter of an aircraft performance model from an input to the model, the input comprising operational or performance data for a different aircraft.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the forms disclosed. Rather, the present disclosure covers all modifications, equivalents, and alternatives falling within the scope of the appended claims.

### BRIEF DESCRIPTION OF THE DRAWINGS

Embodiments in accordance with the present disclosure will be described with reference to the drawings, in which:

FIG. 1(a) is a block diagram illustrating an overview of the primary functional elements and operations of a TASAR system;

FIG. 1(h) is a table listing characteristics or parameters of an individual aircraft that may be relevant to the trajectory and flight planning performed by the TASAR system;

FIG. 2 is a block diagram illustrating the interactions between the Navigation, Surveillance, and Communications functions or operations of a TASAR system;

FIGS. 3(a) and 3(b) are flowcharts or flow diagrams illustrating an adaptive process, method, or operation for modifying an aircraft performance model (APM) used in a TASAR system and that may be used when implementing an embodiment of the disclosed system and methods; and

FIG. 4 is a diagram illustrating elements or components that may be present in a computer device or system configured to implement a method, process, function, or operation, in accordance with some embodiments of the disclosed system and methods.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, controller, etc.) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore not to be taken in a limiting sense.

Over time, aircraft fuel mileage performance (i.e., fuel used per miles flown during a segment of a flight) degrades, typically due to a combination of increased airframe drag and engine degradation. The decrease in fuel mileage performance is quantifiable and can be “predicted” using a trained machine learning model after gathering of sufficient training data. In some cases, training data may be obtained by detecting differences between currently “predicted” or expected aircraft performance (based on the aircraft performance model being used) and actual in-flight performance of an aircraft. In some embodiments, the observed differences between actual aircraft performance and that predicted or expected based on a baseline aircraft performance model may be used to modify the model to more optimally generate trajectory and flight path changes.

By collecting information for a sufficient number of aircraft of the same airframe type (or having other characteristic(s) common to the set of aircraft), a machine learning model can be trained to predict a different aircraft's fuel milage performance (or other characteristic) based on a set of features. For example, a set of data may be collected for each aircraft of the same manufacturer and airframe model (such as a Boeing 747) that includes information on multiple aspects of each aircraft (type of routes flown, miles flown, years in service, performed maintenance, etc.) and its performance (fuel mileage, frequency of repair, nature of repairs, service issues, etc.). A set of this data for multiple aircraft can be used as training data for a machine learning (Mir) model or models. In some examples, the data may be for aircraft of different types that have similar characteristics (such as wingspan, weight, operating altitude, etc.).

Each ML model may be trained to output a prediction or expected value of a specific characteristic of an aircraft whose feature data is used as an input to the trained model. The output may be, for example, predicted fuel milage performance, expected time to next maintenance, expected cost of operating per mile flown, etc. For example a trained model might be used to “predict” how the performance of an individual aircraft or of a set of aircraft would be expected to change over a specific time period or based on the number of miles flown, the number of takeoffs and landings, etc. As another example, a model might be trained to predict the expected drag coefficient for an airframe based on age and/or miles flown. The features on which a ML model is trained may be a subset of the data collected for a group of aircraft. This subset may be those features found to be statistically correlated with a change in aircraft performance, or those broadly describing the characteristics of an aircraft. Over time, more specific features may be used and as a ML model's performance improves, a set of the most relevant features may be identified.

Over time and with further (statistical) analysis, additional sets of “features” may be identified that are correlated with performance changes, such as increases in drag or fuel consumption, or a decrease in time between maintenance or service, etc. Such features may then be used as training data for a model that can be used to generate a prediction of an aspect of the operation of an individual aircraft or set of aircraft having common characteristics. In some embodiments, the outputs of several models may be combined (if desired) to produce a prediction of an aspect of operation based on a larger set of features or from multiple models that incorporate slightly different training algorithms. The individual predictions may be combined as a weighted sum, a fit to a polynomial or curve, or by a suitable statistical means.

In some embodiments, the system and methods described herein apply what is learned about an individual aircraft and/or type of aircraft (e.g., model, type, style) to modify or correct a baseline aircraft performance data model (APM) used in the TASAR system to determine trajectory optimizations, thereby providing improved and in some cases, aircraft-specific recommendations. This is in contrast to conventional approaches that may use the TASAR system but rely on a fixed model that is applied to all aircraft or to all aircraft of a specific type for which the system has a detailed model (such as a Boeing 747, 727, etc.).

As mentioned, the less granular, conventional approach to using a generic aircraft performance model as part of flight planning has several disadvantages; for example, as the airframe (parasitic) drag increases, baseline optimum altitudes for an individual aircraft or set of aircraft of the same type and original specifications may be reduced, even if only slightly. This can be both an operational and a safety concern. However, embodiments can generate more optimal flight trajectories by adjusting how an aircraft is characterized in an aircraft performance model. This may be done by modifying one or more of the parameters of a baseline model, thereby producing improved (and more optimal) flight trajectory outputs from the TASAR system. As more data is obtained from an individual aircraft or even from a set of aircraft sharing common characteristics (such as manufacturer and airframe type), a machine learning model may be trained and used to modify an existing parameter of an aircraft performance model to better represent the individual aircraft or a subset of a group of similar aircraft.

Embodiments of the disclosure are directed to systems, apparatuses, and methods for more effectively providing pilots with optimal suggested route or trajectory changes during flight. In some embodiments, this is achieved by at least two primary improvements: (1) expanding the set of available “models” used in the TASAR system's generation of recommended flight trajectory changes to account for the characteristics of a larger set of aircraft; and (2) modifying a baseline model for a type of aircraft (such as for a Boeing 747) to take into account the operating characteristics and condition of an individual aircraft.

A first area of improvement over conventional approaches may be obtained by collecting data regarding the characteristics of a set of aircraft having a common manufacturer, type (e.g., airframe or class), and in some cases, specific features (such as winglets or other structural features). The data (such as flight miles number of flights, time in service, repair frequency, maintenance issues, deviations from the predicted performance or operating characteristics derived from a baseline model) may be used as input data or “features” for a machine learning algorithm. The training data is used to “teach” the algorithm (using an appropriate label or annotation) how that data impacts an aircraft's performance with regards to one or more performance parameters (such as fuel consumption, lift, drag, etc.).

The collected data may be obtained from on-board sensors (e.g., airspeed, wind resistance, wind velocity, drag, etc.), ground-based systems (e.g., weather conditions, trajectory, etc.), satellites, or airlines records, for example. Once a suitable aircraft performance model has been developed for a specific type or class of aircraft (such as a Boeing 747), that model may be integrated with the TASAR system to provide a more accurate means of flight or trajectory planning for that type or class of aircraft. Such a model for a type or class of aircraft may be created for a plurality of types or classes, i.e., multiple airframes from each of several manufacturers.

Further, as will be described, data collected during the operation of each individual aircraft (each “tail”) may be used as part of a feedback loop to modify an aircraft performance model to make the model specific to the individual aircraft. This will further optimize the trajectory and flight planning data produced by the TASAR system for the individual aircraft. This is expected to lead to improvements in scheduling maintenance, improved fuel consumption, reduced repair costs over the lifetime of an aircraft, lowered operating costs, improved safety, and in some cases, even improved comfort for passengers during flights.

As mentioned, a second area of improvement may be obtained by adapting or modifying a standard or baseline model (or if available, a model such as that produced by implementing the first area of improvement) to specifically tailor it to an individual aircraft. This would provide a more accurate model for use in the TASAR system and one which would be expected to provide the most accurate and reliable form of route planning and trajectory options for a specific aircraft. In some embodiments, a baseline model may be modified using a feedback control loop that collects information on deviations from the performance predicted from the baseline model for an individual aircraft (such as flight time, fuel consumption, etc.). The deviations may be used as part of a process to update or revise a parameter or parameters of the baseline aircraft performance model to make it more accurately reflect the performance characteristics of a specific aircraft (e.g., drag as a function of airspeed).

As an example of the limitations of the present TASAR system with regards to aircraft models, it is believed that the current implementation of the system is limited to aircraft performance models for five different aircraft; these correspond to four different Boeing 737 models and an Airbus A320. This is dearly insufficient for accurately modeling the large variety of aircraft types being flown, much less the characteristics of an individual aircraft.

A conventional implementation of the TASAR system incorporates an aircraft performance model (APM) that is based on the following:

Aircraft Performance Model
There are four forces that impact aircraft performance, one in each direction of upward (lift), downward (gravity), forward (thrust), and backward (drag). All except gravity are variable, and may depend on speed airframe characteristics aircraft weight, among other features;
   In some implementations, the APM is represented in the form of a grid of aircraft drag at a specific airspeed (as described in greater detail below);
      For this representation of an APM, a trained machine learning model may output an expected drag as a function of speed for a stage of a flight for a set of aircraft (e.g., of the same manufacturer and class or type);
      Data collected for a specific aircraft during operation may then be used to modify or adjust the grid to generate an APM for that aircraft;
         Using the aircraft specific APM in the TASAR system will result in producing flight trajectory recommendations that are more optimal for the individual aircraft;

Quantifying Performance
Nautical Air Miles (NAM) is a common framing of aircraft performance and depending on the aircraft it may be per 1,000 pounds for a narrow body like a Boeing 737, or per 10,000 pounds for a wide body like a Boeing 777;

Operating Envelopes
There are various stages of flight known as the operating envelope and these include but are not limited to, flight segments such as climb (which has very heavy fuel burn), cruise (which as a more stable fuel burn), and descent (which is typically light on fuel burn);

Cost Index, or Speed Schedule
In commercial aviation, a Cost Index is assigned on a per flight basis, though some airlines use the same Cost index by default. While the ranges vary by aircraft type, it is typically between 0 and two nines (99) and can also get up to four nines (9999). With Cost Index the range is from an emphasis on flight time reduction (where it's vital that a flight be on time), or fuel reduction (where fuel conservation should be a priority);

Drag Polars
An APM is represented on an X/Y axis where the X axis is airspeed, and the Y axis is drag. Performance models (in the context of a given operating envelop) may be represented as a curve where, as the aircraft goes faster, drag will change. At a certain point, the performance will spike up sharply in a way sometimes loosely referred to as a “hockey stick” and in this case the hockey stick effect on drag occurs because of the generation of a shockwave. At a certain airspeed, and with each successive increase in speed, the drag increases significantly, which negatively impacts fuel burn.

Book/Baseline
When a new aircraft is delivered, it comes with an APM and that APM is referred to as the “Book” APM. It is expected that from the time the aircraft starts to fly, the actual performance will degrade over time, until its next major or “heavy” maintenance after which it will then perform much better. After a heavy maintenance, the aircraft performance may not be the same as Book, and it should be considered a new baseline for the purpose of measurements.

A given flight plan consists of a sequence of waypoints, which are fixed location latitude/longitude points that typically have a three to five letter name. A flight plan will include specifics of anticipated wind strength, altitude, and airspeed. On that basis, a forecast is created for how much fuel will be burned between each waypoint, and there is a published (internally for the pilots) anticipated remaining fuel at each waypoint. In the simplified example shown in the table below, the example suggests that 1,000 pounds of fuel will be burned between every waypoint on the route when it is at cruising altitude based on the baseline aircraft performance model being used for the calculation. When the plane is in flight, the actual amount of fuel burned will often be different, and usually less efficiently than suggested by the book/baseline value.

| | Waypoint | Waypoint | Waypoint | Waypoint | Waypoint | Waypoint | Waypoint | Waypoint | Waypoint | Waypoint |
|---|---|---|---|---|---|---|---|---|---|---|
| | 1 | 2 | 3 | 4 | 5 | 6 | 7 | 8 | 9 | 10 |
| Book/Baseline | 1000 | 1000 | 1000 | 1000 | 1000 | 1000 | 1000 | 1000 | 1000 | 1000 |
| Actual | 975 | 950 | 1001 | 925 | 980 | 940 | 975 | 970 | 980 | 975 |
| Variance | (25.00) | (50.00) | 1.00 | (75.00) | (20.00) | (60.00) | (25.00) | (30.00) | (20.00) | (25.00) |

As mentioned, the current implementation of an aircraft performance model in the TASAR system is in the form of a grid that represents aircraft drag D (measured in newtons) at a specific airspeed (expressed as a Mach value). The drag (D) is equal to a drag coefficient (Cd) times the density of air (r, measured in kg/m³, which is a function of altitude) times on-half of the square of the velocity (V, measured in m/s) times the wing area (A). A Pattern-Based Genetic Algorithm takes as an input wind data provided from a ground station and based on the selected aircraft performance model (APM) and a Cost Index (a range of values that varies by aircraft type), the TASAR system calculates the best vertical and lateral options for a trajectory change, as well as a “combination” recommendation which includes both vertical and lateral optimizations.

As an example, for a Boeing 737, the Cost Index is number that ranges between 1 and 500. For a Boeing 757, the Cost Index ranges between 1 and 9,9999. The Cost Index is typically assigned by an airline and is entered by the pilot into the flight management computer and/or into an application used to access the TASAR system. The Cost Index represents how the airline and/or pilot want to prioritize a reduction in flight time vs. a reduction in fuel consumption. The TASAR system may indicate to the pilot the impact of selecting each option (or Cost Index value or range) on flight time and fuel consumption. This enables the pilot to make an informed decision about any potential change to the current or planned flight trajectory.

While this is beneficial and can assist a pilot to make an informed decision, it is not ideal. As noted, current aircraft performance models used in the TASAR system are static and limited, and therefore are not specific to each individual aircraft (and may not be available for many airframes or types of aircraft). However, by generating and using a larger database of aircraft performance models and parameter sets, embodiments of the system and methods described herein are able to track and monitor aircraft performance at the level of an individual aircraft. Using that information, the system and methods are able to modify a standard or baseline APM to make it more specific to an aircraft and then use the modified APM in the TASAR system to generate more optimal flight plans for that aircraft.

As described, using machine learning (ML), pattern matching, and other forms of “intelligent” data processing, a set of baseline aircraft performance models may be generated, with a separate model for each of a set of aircraft having common characteristics (such as manufacturer and type of airframe). Given a baseline aircraft performance model, the data obtained from an individual aircraft (e.g., fuel consumption, flight time, carbon emissions, airspeed, drag, lift) can be used to determine how the performance characteristics of that specific aircraft differ from the parameters (such as drag vs. airspeed) of the baseline aircraft performance model. This information can be used to improve the model for both the individual aircraft and in some cases for a class or type of aircraft. It is expected that the improvement(s) to an aircraft performance model will become more accurate over time, resulting in a better set of models for use in the TASAR system, and as a result, more optimal flight planning capabilities.

As aircraft (tail)-specific aircraft performance models are derived, there will be an opportunity to use pattern matching to enable the tail-specific performance models to be applied as a predictive tool for a larger set of aircraft. As an example, with a large sample size of Boeing 737-900ER type aircraft, and with knowledge of the age of an aircraft, the maintenance history of an aircraft, and historical flight data (e.g., frequency of short flights, frequency of long flights), it is expected to be able to discover which types of usage have led to the greatest variations in aircraft performance, and at what rate those variations (presumably degradations) are likely to occur, e.g., linear or non-linear as a function of time.

In some embodiments, and for a given airspeed and with a known amount of drag (e.g., as measured by an on-board sensor), the system described herein may “learn” under which operating conditions (e.g., current weight, which varies over the course of a flight, largely due to fuel burn) or external influences (e.g., wind velocity, which can impact both lift and drag) an individual aircraft performs differently than expected (e.g., with respect to flight time or fuel consumption) based on the TASAR flight plan, where the plan was derived from a standard or less aircraft-specific performance model. The system will apply that learning and over time be able to make better and more specific trajectory recommendations for an individual aircraft, and in some cases for types or classes of aircraft with certain characteristics. Over time, a parameter table or data set may become available that represents how a specific individual aircraft varies from a standard or baseline performance model and that information can be used as part of the TASAR system to generate more accurate and optimal flight trajectory recommendations for the individual aircraft.

In addition to more optimal flight planning, the aircraft specific information (as expressed by variations from a standard or baseline performance model) may be used to schedule maintenance and repair more effectively for the individual aircraft. This may be accomplished by providing a data set that tracks how the individual aircraft is “aging” over time (as indicated by an increase in fuel consumption or airframe drag, for example). This information may be combined for a group of aircraft to provide an airline with information regarding how a class of aircraft are expected to degrade in performance over time based on usage patterns. This may assist a mechanic to better identify wear or alignment issues in an aircraft prior to when maintenance might have been indicated by following procedures for a generic example of the aircraft. A more accurate view of performance degradation for a fleet of aircraft may be used for longer term maintenance forecasting, as well as providing a more accurate model for anticipating when an aircraft needs to be replaced. Secondary benefits may include Improvements to scheduling flight times, improved on time performance, enabling more accurate comparisons of competing aircraft for performance and durability, and more realistic trip pricing.

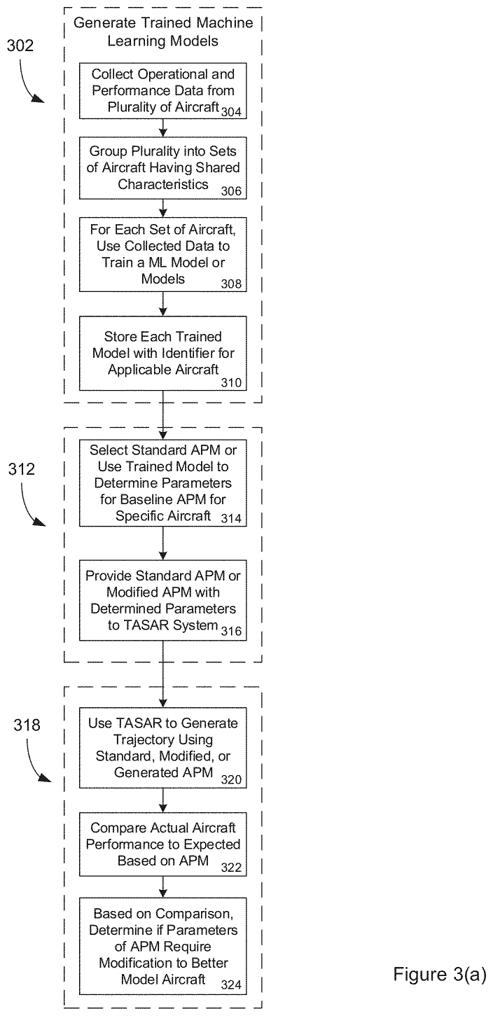

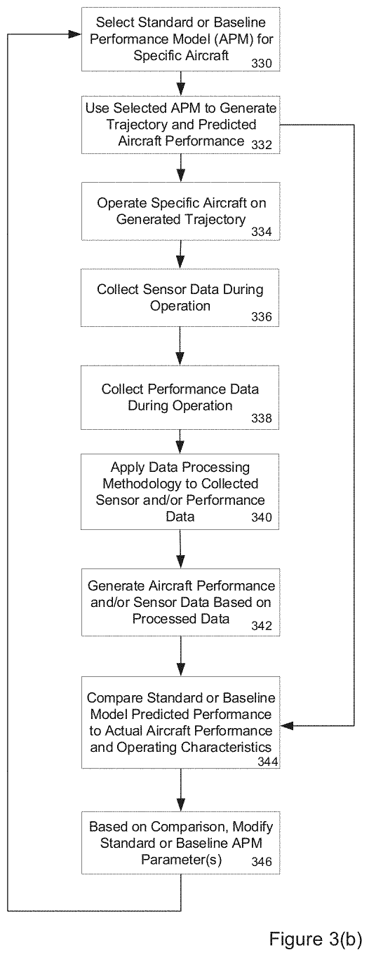

In some embodiments, a combination of Dimensionality Reduction, using the Embedded approach (as described at https://en.wikipedia.org/wiki/Dimensionality_reduction) and Anomaly Detection (as described at https://en.wikipedia.org/wild/Anomaly_detection) may be used to modify an aircraft performance model of the type described herein (i.e., a set of parameters used by the TASAR system to generate flight trajectory options) to make it more closely reflect an individual aircraft. As examples, below are descriptions of how data from an individual aircraft may be collected and used to modify that aircraft's standard or baseline TASAR system aircraft performance model:
Assume that a user accepts a TASAR system recommendation (and in response enters new waypoints, altitude, and airspeed that were recommended and approved by Air Traffic Control), and this recommendation is linked to a preference for a flight time reduction and/or fuel savings (in response to the Cost Index/weighting entered by a Pilot). Embodiments of the disclosure will be able to compare how the actual conditions (such as measured wind speed and direction, drag, and airspeed) differ from what the TASAR system expected, and from that data determine how the actual Flight Time and Fuel Consumption results differed from what was predicted when the recommendation was generated (as suggested by the flowcharts illustrated in FIGS. 3(a) and 3(b));
   In this scenario, Anomaly Detection enables embodiments to identify how trends and variances in lift and airspeed improve or worsen the expected or “predicted” result, as based on a specific performance model/grid;
   In this scenario, Dimensionality Reduction enables embodiments to change the weighting (generally without removal of an input variable) of the various inputs (e.g., wind, convective weather, wind, lift, drag, airspeed, etc.) to generate “better” (more accurate) recommendations;
      When actual fuel consumption differs from expected fuel consumption, it may be the result of a change to the elements of the performance model (drag, thrust, lift, and gravity). These would typically change due to airframe changes or engine degradation. A difference between expected and actual fuel consumption could also (or instead) be a result of a change in performance of the aircraft;
         A performance “change” refers to when the aircraft performance is consistently or repeatedly at a level different from what is expected based on an original (book) or baseline APM. This indicates that the APM for this particular aircraft is stale or out of date such that reliance on the original performance model for calculations of time/fuel/carbon impact will be consistently incorrect. When this occurs, the APM for that aircraft should be updated and that should be considered the new baseline for performance calculations;
         If the change occurs repeatedly, then it may be considered a change in the aircraft performance, but if not, then it is more likely an anomaly that is not related to a pattern;
         If the elements of the aircraft performance model differed from what was assumed when the TASAR system generated the trajectory or flight plan, then it may be possible to isolate which of the three APM parameters that are subject to change (drag, thrust, and lift) is most likely to have contributed to the difference between the observed and the predicted fuel consumption (e.g., using Dimensionality Reduction). This result can be used to decide how to weight each of a set of performance model parameters in deciding whether the observed fuel consumption is an anomaly or is indicative of a change in the aircraft;
Over time, the system and methods described can develop aircraft-specific performance models with higher granularity (i.e., aircraft performance models that are more accurate reflections of individual aircraft or sets of similar aircraft, where similarity may be based on airframe type, time in service, flight miles of service, types of routes flown, etc.) than the standard performance models that are conventionally used in the TASAR system for an entire type or class of aircraft;
   Over time, there may emerge identifiable patterns of changes in a performance model corresponding to an aircraft that are found to be associated with the aircraft undergoing a significant change in performance (i.e., there is a correlation between a change or changes to a model's parameters and a change to observed or measured aircraft performance);
      As an example, the disclosed system may identify a situation when a plane is likely to start performing differently in a way that impacts fuel efficiency (e.g., after 1,000 hours of operation a Boeing 737 900 will start to have an N % decrease in fuel efficiency);
      Similarly, embodiments may determine if flying an aircraft consistently in a manner that differs with respect to one or more of a set of variables (such as airspeed, altitude, outside temperature or wind speed, etc.) produces a long-term impact on engine efficiency, repair, or maintenance costs, etc.

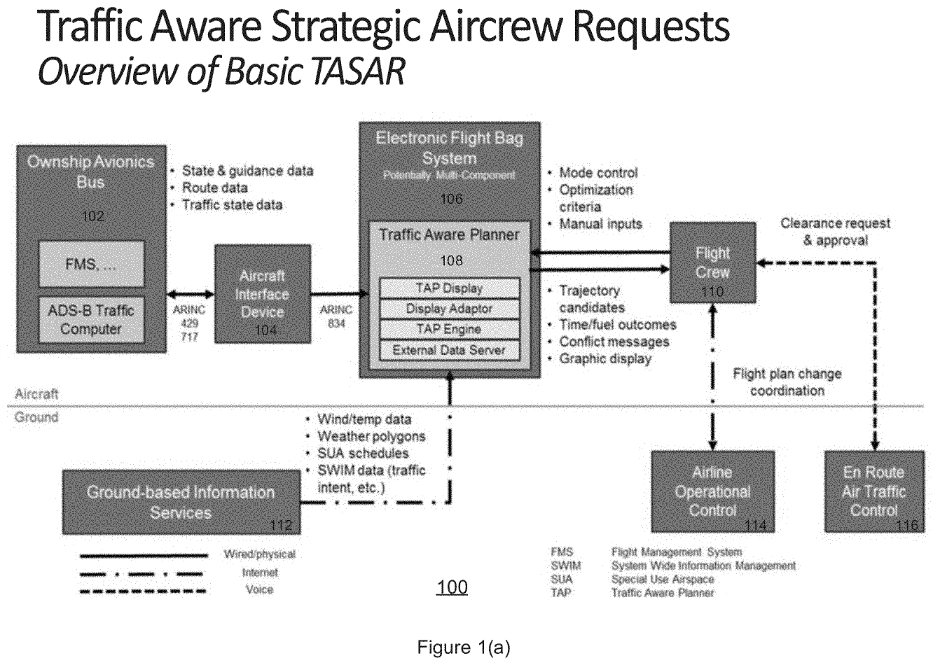

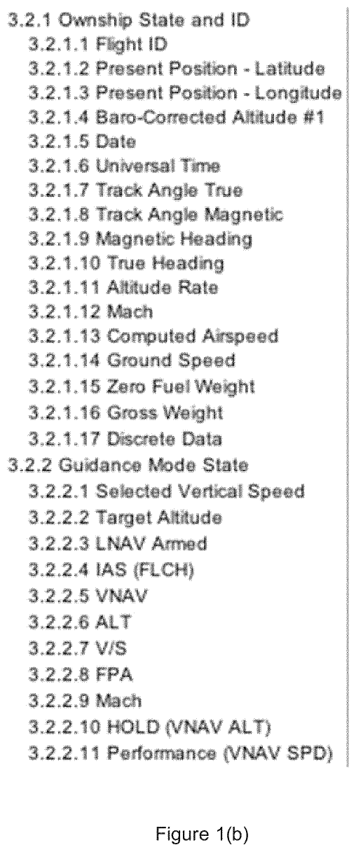

FIG. 1(b) is a table listing characteristics or parameters of an individual aircraft that may be relevant to the trajectory and flight planning performed by the TASAR system. In some embodiments, one or more of these parameters may be modified to determine more accurate trajectory change recommendations using the TASAR system. As an example, in operation, the TASAR TAP Engine (a module of TAP element 108 of FIG. 1(a)) ingests the aircraft state data (e.g., fuel weight, thrust, drag, lift, air speed, track angle, altitude, barometric pressure, and possibly other parameters) in addition to the data for wind, convective weather, air traffic, and special use airspace location. TASAR also uses as inputs the aircraft performance model (which is a table/grid as described), the entered Cost Index, and a list of latitude/longitude points known as waypoints based on an ARINC-424 standard. Every 60 seconds (for example) the system ingests this information and using a pattern-based genetic algorithm, assesses up to hundreds of potential route changes. It isolates the best optimizations of vertical change only, lateral change only, and both lateral and vertical change (known as a “combination”), and those are captured by the user interface and presented to the pilot when the optimizations are expected to provide better performance than the current route the pilots are flying.

Pilots can have the ability to have a minimum savings threshold, since a pilot flying an aircraft burning 10,000 pounds of fuel is not interested in an optimization that saves a miniscule amount of fuel. When the aircraft needs to avoid wind, weather, traffic, or special use airspace, those are treated by the TAP Engine as obstacles, or “no fly” zones. When an aircraft is directing the pilot around an obstacle or set of obstacles, the optimizations may show negative impact on time and fuel, but because they are avoiding an obstacle, the pilot-defined savings threshold is suppressed.

FIG. 1(a) is a block diagram illustrating an overview of the primary functional elements and operations of a TASAR system 100. FIG. 1 includes two primary functional segments, those located on the Aircraft and those that are located on the Ground. This is one representation of how the system can work—some of these components can be provided in multiple configurations or optional arrangements:

Aircraft-Based
Ownship Avionics Bus (102). The TASAR system uses State Data such as weight, airspeed, barometric pressure, and other parameters. In this example, State Data comes from ADS-B traffic information, through it is possible to have traffic as well as active route data (shown here as the Flight Management System, FMS) provided by a ground source (via services known as System Wide Information Management, or SWIM). Data is transferred using a specific set of standards known as ARINC and in this example, the data complies with ARINC-429 and ARINC-717 standards;
   ADS-B: Automatic Dependent Surveillance-Broadcast. The source is each individual aircraft which must be equipped for ADS-B “Out”. It broadcasts the aircraft identification, altitude, speed, heading for ADS-B “In” equipment to receive. ADS-B receivers are located both on other aircraft and on the ground and collectively show the real-time aircraft traffic in the National Airspace System (NAS). Receivers on the ground are connected via the FAA to the Internet, allowing individuals and companies to interrogate any aircraft in the NAS to determine its ID, heading, speed, altitude. TASAR in combination with the assignee's application uses this information to make recommendations for route changes to pilots which will not conflict with other aircraft;
Aircraft Interface Device (AID-104). This is a piece of hardware that resides on the aircraft. In some cases special AIDs will be installed for the software described herein, and in other cases the system can obtain the State Data it needs from an AID already onboard the aircraft (such as the in-flight connectivity server provided by a vendor such as Intelsat/Gogo);
Electronic Flight Bag (EFB-106). The EFB is a device, such as a laptop or tablet computer (e.g., an iPad, manufactured by APPLE) that is assigned to a pilot. A set of applications the pilot uses while in flight is installed on the EFB. This typically includes a set of modules or functions for the Traffic Aware Planner (TAP) 108. The TAP is used to generate the trajectory optimizations and recommendations. The TAP may incorporate or have access to an aircraft performance model (APM) used as part of generating the trajectory optimizations or recommendations;
   Typically, APM parameter values are accessed (and if needed modified) on the ground initially by engineers who are validating the data;
      As described herein, in some embodiments, APM parameters may also be modified using a trained machine learning model;
   The initial or modified APM is sent back to the aircraft via an appropriate ground and airborne platform (such as that provided by the assignee of the present application) and acquired by the EFB application, where it is used to calculate trajectory recommendations for the pilot;
   Pilots do not have direct access the APM or the ability to change a value in the APM. If a pilot wants to change the flight planning application's primary objective from saving time to saving fuel, the pilot can do that by choosing an option in the application (“Optimize for fuel” vs “Optimize for Time” or “Optimize for Trip Cost”) and/or they can change the value of the Cost Index to lower it. This will orient the application to the portion of the APM table which is more fuel efficient;
   TAP is a subset of the overall system and is where the route change recommendations are generated. A pilot interfaces with TAP through a user interface. TAP and the user interface can be co-resident on a single device or TAP can be on an AID 104 which communicates with the user interface, with the user interface on a device the pilot can interface with (e.g., tablet, laptop, PC), typically via Wi-Fi;
Flight Crew (110). The flight crew (e.g., pilot, co-pilot, navigator) receives trajectory optimization candidates, as well as route changes of their own choosing (or one recommended by Air Traffic Control (ATC)), and it is up to the pilot to decide which changes to accept. Most airlines have both vertical and horizontal thresholds for approval and if a Pilot is pursuing a route change outside of those thresholds, they are expected to contact their own internal dispatch team for approval;

Ground-Based
Ground-Based Information Services (112). There are several options for ground feeds. The most common are for wind, convective weather (specifically CTO/CTH), special use airspace (US), and SWIM if there is not access to an internal bus for active route information on the aircraft. Additional ground feeds may include forecast winds, clear air turbulence, and volcanic ash, among others;
Airline Operational Control (114). This is referred to as Dispatch by many airlines, and dispatch may need to approve trajectory changes beyond certain vertical and lateral thresholds;
En Route Air Traffic Control (ATC-116). No change can be made to an active route without approval from ATC, whether they initiated the change or not. SWIM is an FAA service so largely only available in the continental US.

As an example of an alternative architecture that may be used in implementing an embodiment of the system and methods disclosed herein, the assignee has developed a mechanism for making the APM available for analysis, modification, and use by the TAP engine. As described, the APM is a file, or in some implementations a table. For the flight planning system to generate trajectory recommendations, the TAP engine accesses the APM. The assignee has developed an architecture where APM data can be sent from the ground to the air on the AID 104 and provides a service that retrieves the APM for the TAP engine to use. The same architecture allows the system to “push” data to a ground-based server so that, for example, a trained machine learning model can be used to detect changes and modify a parameter of the APM.

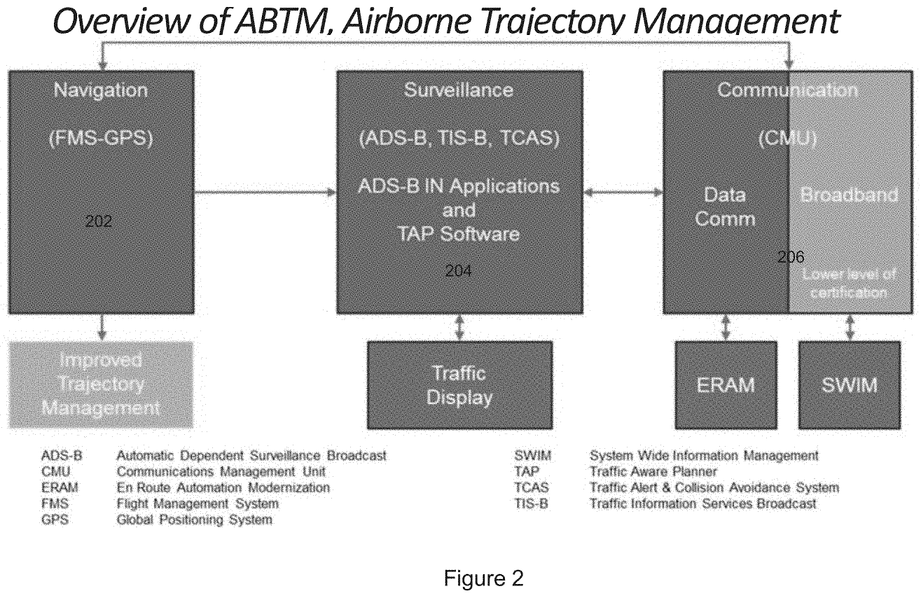

FIG. 2 is a block diagram illustrating the interactions between the Navigation, Surveillance, and Communications functions or operations of a TASAR system. FIG. 2 illustrates certain high-level functional aspects of what is shown in FIG. 1(a). For example:
Navigation (202). This functional capability is where suggested route optimizations are generated by TAP (although TAP may also reside in other functional areas);
Surveillance (204). This is where real time traffic data is collected and processed; and
Communication (206). Architecturally, there are multiple ways the system can obtain the data it needs to make the route optimization calculations.

As mentioned, in some embodiments, the APM is provided by an onboard service and is pushed (from a ground-based system) to TAP at the beginning of a flight. Actual performance data is pushed to the ground, where a machine learning model may be applied to generate updated parameters for an APM, with the modified APM then pushed back to the appropriate aircraft for use in generating more accurate flight plans and trajectory recommendations.

FIGS. 3(a) and 3(b) are flowcharts or flow diagrams illustrating an adaptive process, method, or operation for modifying an aircraft performance model (APM) used in a TASAR system and that may be used when implementing an embodiment of the disclosed system and methods.

As shown in FIG. 3(a), an embodiment of the system and methods described herein may include the three primary functions or operations illustrated:
A process or function to generate one or more trained machine learning (ML) models (represented by processes 302 in the figure);
   This will typically include collecting a set of training data representing operational and performance related aspects for each of a plurality of aircraft (represented by process 304 in the figure);
      The operational data may include, but is not limited to, or required to include:
         Manufacturer;
         Airframe model or type;
         Date of first use in service;
         Miles flown in service;
         Number of flights flown;
         Maintenance schedule;
         Date of most recent modification to APM;
         Seasonality, particularly temperature;
         Number of landings;
         Routes flown;
         Heavy check dates;
         Flight gross weights;
         Turbulence reports (planes have G sensors on them to track this);
      The performance data may include, but is not limited to, or required to include:
         Fuel consumption per mile flown;
         Measured drag of airframe in flight for each of multiple flight segments;
         Measured lift of airframe in flight for each of multiple flight segments;
         Measured engine thrust in flight for each of multiple flight segments;
         Fuel flow;
         N % of main disc (what % of power the main fan is running at and for how long);
         Engine temperature;
         Gross weight;
         Density altitude;
         Temperature;
   A process to group the plurality of aircraft into sets of aircraft having shared characteristic(s) (represented by process 306 in the figure);
      This segments the data into groups of training data for aircraft that are treated as similar enough for purposes of training the model, such as by being of the same airframe type, used for similar flights, of a similar age in service, etc.;
      As more is learned about the factors that have the greatest impact on aircraft performance, these segments may be altered to permit exploring the impact of other factors on the parameters of an aircraft performance model;
   For each of the groups of aircraft, use the collected data to train one or more machine learning models (as represented by process 308 in the figure);
      The data used for training a specific model and the label or annotation used will depend on the features thought to be most significant and the aircraft performance model parameter the machine learning model is being trained to “predict” (i.e., the drag, etc.);
      The features used to train the model may be a subset of the data collected for the aircraft in the group, and may be selected using statistical analysis to determine the features most closely correlated with a change to the APM parameter or by another suitable method;
      The trained model operates to receive certain information regarding an aircraft (the selected features, such as manufacturer, airframe type, years in service, miles flown in service) and in response generate an output indicating the predicted or expected value of a parameter of an APM model for that aircraft, or other data that can be used to generate such a parameter;
   trained model is stored in a data storage element, along with information identifying the applicable aircraft to which the model may be applied (represented by process 310 in the figure);
A process or function to determine an aircraft performance model (APM) for use with the TASAR system to generate trajectory optimizations (represented by processes 312 in the figure);
   A process to select a standard APM or use a trained ML model to generate a set of parameters for use in an aircraft-specific APM (represented by process 314 in the figure);
      The standard APM may be one of those indicated (i.e. for an aircraft for which a APM model is available);
         Even if a standard APM is available, it may be beneficial to use a more realistic set of APM parameters that can be obtained using a trained model that takes into account aircraft years in service, miles flown, etc.;
      If a standard APM is not available, or if a more accurate and aircraft-specific APM is desired, then use the appropriate trained machine learning model to generate one or more parameters for use in the aircraft-specific APM;
         Either the standard, modified, or generated APM may be considered a baseline APM for the specific aircraft;
   A process to provide the standard, modified, or generated APM to the TASAR system for use in its trajectory optimization calculations (represented by process 316 in the figure);
A process or function to compare the “predicted” or expected operational performance of the specific aircraft based on the selected APM (i.e., the standard modified, or generated APM) to its actual or observed performance as part of a process to update or revise the APM to better reflect the performance characteristics of the actual aircraft (represented by processes 318 in the figure);
   A process to use the TASAR system to generate a trajectory or trajectory recommendation using the selected APM (represented by process 320 in the figure);
   A process to compare the actual performance of the aircraft to the expected or predicted performance based on the selected APM (represented by process 322 in the figure);
      This may involve collecting data regarding fuel consumption, drag, lift, or engine thrust during one or more flights of the aircraft and comparing those to the performance predicted using the APM model (such as the fuel consumption during a flight segment);
   A process to determine if a parameter of the selected APM should be modified for future use in the TASAR system in response to and based on the comparison (represented by process 324 in the figure);
      this may include performing a sensitivity analysis, or application of the Anomaly Detection or Dimensionality Reduction techniques described to determine the significance of a difference between the predicted performance and the actual performance.

FIG. 3(b) shows in greater detail the steps or stages that may be used to implement portions of the processes shown in stage(s) 318 of FIG. 3(a). As shown in FIG. 3(b):
a standard or baseline APM (one generated by modifying parameters in a standard or other APM) is selected for use with a specific aircraft (or set of aircraft), as suggested by step or stage 330;
the selected APM is input to the TASAR system and used by TASAR to generate a recommended trajectory or trajectory change, and a predicted or expected performance for the aircraft during one or more flight segments, as suggested by step or stage 332;
   a the APM may also be used to generate predicted sensor readings during operation of the aircraft;
the aircraft is then operated along the generated trajectory (once or for multiple flights), as suggested by step or stage 334;
   a during operation, sensors may be used to collect data regarding wind, drag, or other measurables, as suggested by step or stage 336;
   during or after operation, data is collected (and if necessary, processed) to determine the aircraft's performance during the flight or flights, as suggested by step or stage 338;
      this data or signal processing may include one or more of the techniques described, e.g., sensitivity analysis, Anomaly Detection, or Dimensionality Reduction, as suggested by step or stage 340;
      Based on the processed aircraft performance or sensor data, generate performance and sensor data that can be compared to the predicted values (this is optional and if necessary to permit a comparison), as suggested by step or stage 342;
   Compare the predicted or expected performance and/or sensor data derived from the standard or baseline APM used by the TASAR system to the actual performance data and/or sensor data of the aircraft during operation, as suggested by step or stage 344;
   Based on the comparison, modify a parameter or parameters in the standard or baseline APM to better reflect the actual operation and/or performance of the individual aircraft, as suggested by step or stage 346;
      This might include representing the drag vs. airspeed relationship differently, modifying one or more of the drag values for a specific speed, etc.;
         In some embodiments, a formula or function might be generated that generates the drag as a function of airspeed, or another APM parameter as a function of a second parameter;
         Given sufficient data, it may be possible to generate a polynomial or fit the data to another type of function;
         In some cases, and with sufficient data, it may be possible to generate a function that outputs the drag or another parameter as a function of flight miles, years in service, or another factor for a specific aircraft and incorporate that into a process to determine a parameter or parameters of an APM;
      The modified APM is then used in a feedback loop to step or stage 330 for use in the TASAR system for that aircraft and is expected to generate more accurate and applicable trajectory recommendations and flight plans;
         In some embodiments, the APM or APM parameters determined for a specific aircraft might be used as a baseline APM for another aircraft;
         This may be preferable to using a standard APM when sufficient data cannot be obtained for the other aircraft;
         Given sufficient data, it may be possible to identify those APM parameters most likely to change over time for aircraft of a specific type or class—this could allow insertion of automatic changes to those parameters as a function of time and/or aircraft flight time into a standard or baseline model when a plane-specific model is not available;

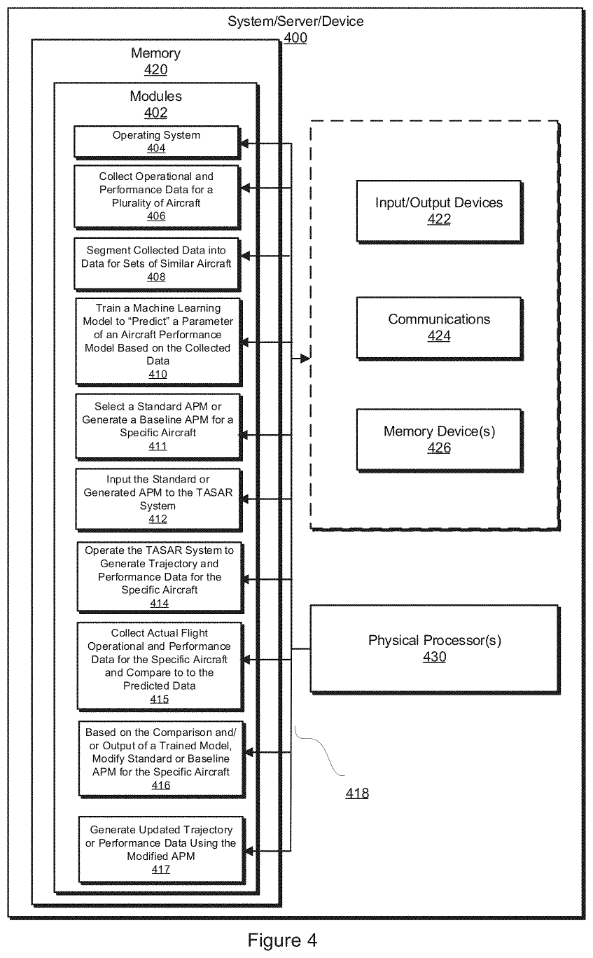

FIG. 4 is a diagram illustrating elements or components that may be present in a computer device or system configured to implement a method, process, function, or operation, in accordance with some embodiments of the disclosed system and methods. As noted, in some embodiments, the disclosed system and methods may be implemented in the form of an apparatus that includes a processing element and set of executable instructions. The executable instructions may be part of a software application and arranged into a software architecture. In general, an embodiment may be implemented using a set of software instructions that are designed to be executed by a suitably programmed processing element (such as a CPU, GPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The computer-executable instructions that are contained in the modules or in a specific module may be executed by the same or by different processors. For example, certain of the operations or functions performed as a result of the execution of the instructions contained in a module may be the result of one or more of a client device, backend device, or a server executing the instructions. Thus, although FIG. 4 illustrates a set of modules which taken together perform multiple functions or operations, these functions or operations may be performed by different devices or system elements, with certain of the modules being associated with those devices or system elements.

Each application module or sub-module may correspond to a particular function, method, process, or operation that is implemented by the module or sub-module (e.g., a function or process related to “model” adjustment or improvement based on characteristics of a specific aircraft). Thus, such function, method, process, or operation may include those used to implement one or more aspects of the disclosed system and methods, such as for:
Generating/Creating a larger set of baseline aircraft performance models for use in the TASAR system;
   a Collecting specific data for each of a plurality of aircraft of a similar type, model, manufacturer, etc.;
   a Constructing a trained ML model based on specific characteristics (features) of the plurality of aircraft (or a subset) and the impact of that characteristic or characteristics on performance (as expressed by a parameter of an APM);
      Data may be collected from logs, onboard sensors, ground based tracking stations, etc.;
      Aircraft performance is a measure of pounds of fuel consumed per nautical mile. The four factors used to calculate this include lift, thrust, drag, and gravity. Tracking “actual” fuel consumption per nautical mile enables documentation of the conditions under which an aircraft performs differently from a base or expected set of performance characteristics;
   Training one or more ML models to be used to predict or classify how a parameter of a TASAR model should be altered for a specific aircraft or set of aircraft based on the input features;
Using a standard APM or one modified using an output of a trained ML model to generate a baseline APM for a specific aircraft or set of aircraft;
Inputting the standard or modified APM into the TASAR system and generating a trajectory and expected performance data;
Comparing actual flight operational data and fuel consumption of an individual aircraft or set of aircraft to that “predicted” by the TASAR system based on a standard aircraft performance model or a previously generated baseline APM;
Based on the comparison, determining how to modify the standard or generated APM to incorporate what is learned from the comparison and in some cases, from an output of a trained ML model or models; and
Generating updated flight trajectory recommendations using the TASAR system;
   Prior to flight based on age, usage of aircraft;
   In real-time using on-board sensor data.

In some embodiments, the system and methods may be used to achieve a specific Cost Index (which may be expressed as a range) as part of a trade-off between time and/or fuel savings for a particular flight;
To factor Cost Index into TASAR and use with an APM for specific aircraft, a formula or rule may be used to balance time and fuel prioritization—as an example, see https://blog.openairlines.com/top-10-facts-or-myths-about-cost-index;
   It is typically the decision of an airline to identify a particular Cost Index for a given flight;
      As an example, assume two planes are leaving New York, with one headed for Phoenix and the other for London. Flights tend to be assigned an arrival “window” which means that the destination airport has a slot for them in their flight arrivals plan. If Phoenix is not known to be a very busy airport and it is easy to get the plane to a gate, then the airline may choose a Cost Index that optimizes for fuel consumption because even if there are delays, or if a plane misses its arrival window, the aircraft should still be able to land without having to circle the airport before being allowed to land;
      In contrast, if London is known to be extremely busy, where missing an arrival window could result in a significant delay in waiting for clearance to land, that flight is more likely to be assigned a Cost Index that optimizes for time. In optimizing for time, the aircraft may end up burning more fuel than it might otherwise, but if the alternative is burning an hour of fuel while circling because of a missed arrival window, that is usually going to be an acceptable tradeoff;

In some embodiments, the system and methods may be used to assist in understanding the fuel efficiency of an individual aircraft compared to what it was when it was built (i.e., the “Baseline” performance). The system and methods may also be used to understand the reason(s) fora suggested route change and the impact of the route change in the context of the Cost Index target, where such reasons or factors may include:
Hazards. In the case of hazards such as traffic, weather, or special use airspace, the user will see on the screen that the system is recommending a change to avoid a hazard;
Winds. The user will not get information from the system when winds (such as shifting from headwinds to tailwinds by changing altitude) will result in an optimization. The user can choose to look at the screen and use a “slider bar” on some user interfaces to compare winds at the current altitude vs. the recommended altitude;
Aircraft Performance Model. There will be cases where TAP generates an optimization based purely on an aircraft performance model. There is nothing visual provided for the user to understand this option, and it would be up to the organization in charge of the user interface how they choose to communicate this type of optimization to their pilots.

The application modules and/or sub-modules may include any suitable computer-executable code or set of instructions (e.g., as would be executed by a suitably programmed processor, microprocessor, or CPU), such as computer-executable code corresponding to a programming language. For example programming language source code may be compiled into computer-executable code. Alternatively, or in addition, the programming language may be an interpreted programming language such as a scripting language. The processor or processors may be incorporated in an apparatus, server, client or other computing or data processing device operated by, or in communication with, other components of the system.

As shown in FIG. 4, system 400 may represent a server or other form of computing or data processing device. Modules 402 each contain a set of executable instructions, where when the set of instructions is executed by a suitable electronic processor (such as that indicated in the figure by “Physical Processor(s) 430”), system (or server or device) 400 operates to perform a specific process, operation, function or method. Modules 402 are stored in a memory 420, which typically includes an Operating System module 404 that contains instructions used (among other functions) to access and control the execution of the instructions contained in other modules. The modules 402 in memory 420 are accessed for purposes of transferring data and executing instructions by use of a “bus” or communications line 418, which also serves to permit processor(s) 430 to communicate with the modules for purposes of accessing and executing a set of instructions. Bus or communications line 418 also permits processor(s) 430 to interact with other elements of system 400, such as input or output devices 422, communications elements 424 for exchanging data and information with devices external to system 400, and additional memory devices 426.

Modules 402 may contain one or more sets of instructions for performing a method that is described with reference to FIGS. 3(a) and/or 3(b). These modules may include those illustrated but may also include a greater number or fewer number than those illustrated.
For example, one or more modules may contain instructions that implement a process or function to generate one or more trained machine learning (ML) models (represented by processes 302 in FIG. 3);
   This will typically include collecting a set of training data representing operational and performance related aspects for each of a plurality of aircraft (as suggested by module 406 in FIG. 4);
      The operational data may include, but is not limited to, or required to include
         Manufacturer;
         Airframe model or type;
         Date of first use in service;
         Miles flown in service;
         Number of flights flown;
         Other factors, as described herein;
      The performance data may include, but is not limited to, or required to include:
         Fuel consumption per mile flown;
         Measured drag of airframe in flight for each of multiple flight segments;
         Measured lift of airframe in flight for each of multiple flight segments;
         Measured engine thrust in flight for each of multiple flight segments;
         Other factors, as described herein;
   A process to group the plurality of aircraft into sets of aircraft having shared characteristic(s) (as suggested by module 408 in the figure);
      This segments the data into groups of training data for aircraft that are treated as similar enough for purposes of training the model, such as by being of the same airframe type, used for similar flights, of a similar age in service, etc.;
      As more is learned about the factors that have the greatest impact on aircraft performance, these segments may be altered to permit exploring the impact of other factors on the parameters of an aircraft performance model;
   For each of the groups of aircraft, use the collected data to train one or more machine learning models (as suggested by module 410 in the figure);
      The data used for training a specific model and the label or annotation used will depend on the features thought to be most significant and the aircraft performance model parameter the machine learning model is being trained to “predict” (i.e., the drag, etc.);
      The features used to train the model may be a subset of the data collected for the aircraft in the group and may be selected using statistical analysis to determine the features most closely correlated with a change to the APM parameter or by another suitable method;
      The trained model operates to receive certain information regarding an aircraft (the selected features, such as manufacturer, airframe type years in service, miles flown in service) and in response generate an output indicating the predicted or expected value of a parameter of an APM model for that aircraft, or other data that can be used to generate such a parameter;
   Each trained model may be stored in a data storage element, along with information identifying the applicable aircraft to which the model may be applied;
A process or function to select or determine an aircraft performance model (APM) for use with the TASAR system to generate trajectory optimizations (represented by processes 312 in FIG. 3);
   process to select a standard APM or use a trained ML model to generate a set of parameters for use in an aircraft-specific APM (as suggested by module 411 in FIG. 4);
      The standard APM may be one of those indicated (i.e., for an aircraft for which a APM model is available);
         Even if a standard APM is available, it may be beneficial to use a more realistic set of APM parameters that can be obtained using a trained model that takes into account aircraft years in service, miles flown, etc.;
      If a standard APM is not available, or if a more accurate and aircraft-specific APM is desired, then use the appropriate trained machine learning model to generate one or more parameters for use in the aircraft-specific APM;
         Either the standard, modified, or generated APM may be considered a baseline APM for the specific aircraft;
   A process to provide the standard, modified, or generated APM to the TASAR system for use in its trajectory optimization calculations (as suggested by module 412 in the figure);
A process or function to compare the “predicted” or expected operational performance of the specific aircraft based on the selected APM (i.e., the standard, modified, or generated APM) to its actual or observed performance as part of a process to update or revise the APM to better reflect the performance characteristics of the actual aircraft (represented by processes 318 in FIG. 3);
   A process to use the TASAR system to generate a trajectory or trajectory recommendation using the selected APM (as suggested by module 414 in the figure);
   A process to compare the actual performance of the aircraft to the expected or predicted performance based on the selected APM (as suggested by module 415 in the figure);
      This may involve collecting data regarding fuel consumption, drag, lift, or engine thrust during one or more flights of the aircraft and comparing those to the performance predicted using the APM model (such as the fuel consumption during a flight segment);
   A process to determine if a parameter of the selected APM should be modified for future use in the TASAR system in response to and based on the comparison (as suggested by module 416 in the figure);
      this may include performing a sensitivity analysis, or application of the Anomaly Detection or Dimensionality Reduction techniques described to determine the significance of a difference between the predicted performance and the actual performance;
   a process to generate an updated trajectory and/or performance data for the specific aircraft based on the revised or modified APM (as suggested by module 417 of the figure).

In some embodiments, certain of the methods, models or functions described herein may be embodied in the form of a trained neural network or machine learning model, where the network or model is implemented by the execution of a set of computer-executable instructions. The instructions may be stored in (or on) a non-transitory computer-readable medium and executed by a programmed processor or processing element. The specific form of the method, model or function may be used to define one or more of the operations, functions, processes, or methods used in the development or operation of a neural network, the application of a machine learning technique or techniques, or the development or implementation of an appropriate decision process. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

A machine learning model is a set of layers of connected neurons that operate to make a decision (such as a classification) regarding a sample of input data. A model is typically trained by inputting multiple examples of input data and an associated correct “response” or decision regarding each set of input data. Thus, each input data example is associated with a label or other indicator of the correct response that a properly trained model should generate. The examples and labels are input to the model for purposes of training the model. When trained (i.e., the weights connecting neurons have converged and become stable or within an acceptable amount of variation), the model will operate to respond to an input sample of data to generate a correct response or decision.

It should be understood that the embodiments as described above can be implemented in the form of control logic using computer software in a modular or integrated manner. Based on the disclosure and teachings provided herein, a person of ordinary skill in the art will know and appreciate other ways and/or methods to implement the embodiments using hardware and a combination of hardware and software.

Any of the software components, processes or functions described in this application may be implemented as software code to be executed by a processor using any suitable computer language such as Python, Java, Javascript, C++ or Perl using conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the claims unless otherwise claimed. No language in the specification should be construed as indicating any non-claimed element as essential to each embodiment.

As used herein (i.e., the claims, figures, and specification) the term “or” is used inclusively to refer items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this disclosure. Accordingly, the present disclosure is not limited to the embodiments described above or depicted in the drawings, and various embodiments and modifications can be made without departing from the scope of the claims below.

That which is claimed is:

1. A system for providing pilots with suggested route or trajectory changes, comprising:
a set of computer-executable instructions;
a processor or processors programmed to execute the set of instructions, wherein when executed, the instructions cause the processor or processors to
obtain a baseline model representing flight performance parameters of an aircraft;
based on the baseline model, generate a flight trajectory and expected flight performance parameters for the aircraft following that trajectory;
monitor actual flight performance parameters as the aircraft is flown along the generated flight trajectory;
compare the actual flight performance parameters to the expected flight performance parameters;
determine if there is a difference between the actual flight performance parameters and the expected flight performance parameters; and
if there is a difference, then modifying the baseline model based on the difference.

2. The system of claim 1, wherein the instructions further cause the processor or processors to:
generate a revised trajectory using the modified baseline model; and
present the revised trajectory to a pilot.

3. The system of claim 1, wherein the flight performance parameters of an aircraft comprise a measure of the drag on the aircraft as a function of airspeed.

4. The system of claim 1, wherein the baseline model is one of a set of aircraft performance models based on one or more of the manufacturer, airframe, or age of the aircraft.

5. The system of claim 4, wherein the set of aircraft performance models is obtained by a process comprising:
collecting operational and performance data for each of a plurality of aircraft;
training a machine learning model to output a parameter of an aircraft performance model from an input to the model, the input comprising operational or performance data for a different aircraft.

6. The system of claim 5, wherein the operational and performance data comprises one or more of:
a manufacturer of each of the plurality of aircraft;
an airframe of each of the plurality of aircraft;
a measure of the miles in service of each of the plurality of aircraft;
a measure of the time in service of each of the plurality of aircraft;
a measure of a force on each of the plurality of aircraft at a specified airspeed for each of the plurality of aircraft; and
a measure of the fuel consumption for a flight segment for each of the plurality of aircraft.

7. The system of claim 1, wherein the modified baseline model is an aircraft performance model having a plurality of parameters, and wherein the baseline model is modified by adjusting one or more of the parameters using a trained machine learning model that outputs a parameter of the baseline model in response to an input to the machine learning model.

8. The system of claim 1, wherein determining if there is a difference between the actual flight performance parameters and the expected flight performance parameters further comprises one or more of applying a statistical method, a filter, or a threshold operation to the actual flight performance parameters and the expected flight performance parameters.

9. A method comprising:
obtaining a baseline model representing flight performance parameters of an aircraft;
based on the baseline model, generating a flight trajectory and expected flight performance parameters for the aircraft following that trajectory;
monitoring actual flight performance parameters as the aircraft is flown along the generated flight trajectory;
comparing the actual flight performance parameters to the expected flight performance parameters;
determining if there is a difference between the actual flight performance parameters and the expected flight performance parameters; and
if there is a difference, then modifying the baseline model based on the difference.

10. The method of claim 9, further comprising:
generating a revised trajectory using the modified baseline model; and
presenting the revised trajectory to a pilot.

11. The method of claim 9, wherein the baseline model is one of a set of aircraft performance models based on one or more of the manufacturer, airframe, or age of the aircraft.

12. The method of claim 11, wherein the set of aircraft performance models is obtained by a process comprising:
collecting operational and performance data for each of a plurality of aircraft;
training a machine learning model to output a parameter of an aircraft performance model from an input to the model, the input comprising operational or performance data for a different aircraft.

13. The method of claim 12, wherein the operational and performance data comprises one or more of:
a manufacturer of each of the plurality of aircraft;
an airframe of each of the plurality of aircraft;
a measure of the miles in service of each of the plurality of aircraft;
a measure of the time in service of each of the plurality of aircraft;
a measure of a force on each of the plurality of aircraft at a specified airspeed for each of the plurality of aircraft; and
a measure of the fuel consumption for a flight segment for each of the plurality of aircraft.

14. The method of claim 9, wherein the modified baseline model is an aircraft performance model having a plurality of parameters, and wherein the baseline model is modified by adjusting one or more of the parameters using a trained machine learning model that outputs a parameter of the baseline model in response to an input to the machine learning model.

15. The method of claim 9, wherein the flight performance parameters of an aircraft comprise a measure of the drag on the aircraft as a function of airspeed.

16. A set of computer-executable instructions, wherein when executed by a processor or processors, the set of instructions cause the processor or processors to perform one or more operations or functions, where the operations or functions comprise:
obtaining a baseline model representing flight performance parameters of an aircraft;
based on the baseline model, generating a flight trajectory and expected flight performance parameters for the aircraft following that trajectory;
monitoring actual flight performance parameters as the aircraft is flown along the generated flight trajectory;
comparing the actual flight performance parameters to the expected flight performance parameters;
determining if there is a difference between the actual flight performance parameters and the expected flight performance parameters;
if there is a difference, then modifying the baseline model based on the difference;
generating a revised trajectory using the modified baseline model; and
presenting the revised trajectory to a pilot.

17. The set of computer-executable instructions of claim 16, further comprising instructions that cause the processor or processors to:
generate a set of baseline aircraft performance models by collecting operational and performance data for each of a plurality of aircraft; and
train a machine learning model to output a parameter of an aircraft performance model from an input to the model, the input comprising operational or performance data for a different aircraft.

18. The set of computer-executable instructions of claim 17, wherein the operational and performance data comprises one or more of:
a manufacturer of each of the plurality of aircraft;
an airframe of each of the plurality of aircraft;
a measure of the miles in service of each of the plurality of aircraft;
a measure of the time in service of each of the plurality of aircraft;
a measure of a force on each of the plurality of aircraft at a specified airspeed for each of the plurality of aircraft; and
a measure of the fuel consumption for a flight segment for each of the plurality of aircraft.

19. The set of computer-executable instructions of claim 16, wherein the baseline model is an aircraft performance model having a plurality of parameters, and the set of instructions further comprise instructions that cause the processor or processors to modify the baseline model by adjusting one or more of the parameters using a trained machine learning model that outputs a parameter of the baseline model in response to an input to the machine learning model.

20. The set of computer-executable instructions of claim 16, wherein the flight performance parameters of an aircraft comprise a measure of the drag on the aircraft as a function of airspeed.
